(19) United States
(12) Patent Application Publication
(10) Pub. No.: US 2026/0352814 A1
(43) Pub. Date: Nov. 5, 2026

(54) INTRA PREDICTION MODE IMPROVEMENTS BASED ON AVAILABLE REFERENCE SAMPLES

(71) Applicant: InterDigital CE Patent Holdings, SAS, Paris (FR)

(72) Inventors: Kevin REUZÉ, Cesson-Sevigne (FR); Thierry DUMAS, Cesson-Sevigne (FR); Karam NASER, Cesson-Sevigne (FR); Philippe BORDES, Cesson-Sevigne (FR)

(21) Appl. No.: 19/119,320

(22) PCT Filed: Sep. 26, 2023
(86) PCT No.: PCT/EP2023/076616

§ 371 Date: Apr. 8, 2025

(30) Foreign Application Priority Data
Oct. 11, 2022 (EP) 22306523.6
Dec. 7, 2022 (EP) 22306799.2
Apr. 5, 2023 (EP) 23305496.4

(51) Int. Cl. H04N 19/11; H04N 19/105; H04N 19/176

(52) U.S. Cl. CPC H04N 19/11; H04N 19/105; H04N 19/176

(57) ABSTRACT

In one implementation, the wide-angle process can be modified to disallow Intra Prediction Modes (IPMs) that would make use of padded reference samples, especially when other IPMs would make use of available reference samples. More generally, depending on whether the reference samples are available or not, certain intra prediction modes can be removed or added, or the MPMs can be reordered. The signaling process can then be modified to handle additional modes or removed modes, especially if this can lead to different numbers of IPMs. The storage and propagation of intra modes can also be modified to handle the change made to IPMs.

### TECHNICAL FIELD

The present embodiments generally relate to a method and an apparatus for intra prediction in video encoding and decoding.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

According to an embodiment, a method of video decoding is presented, comprising: identifying availability of one or more reference samples for a block to be decoded in a picture; obtaining a set of intra prediction modes for said block, responsive to said availability of said one or more reference samples; obtaining an intra prediction mode from said set of intra prediction modes; and performing intra prediction for said block to be decoded to form a prediction block for said block, based on said intra prediction mode for said block.

According to another embodiment, a method of video encoding is presented, comprising: identifying availability of one or more reference samples for a block to be encoded in a picture; obtaining a set of intra prediction modes for said block, responsive to said availability of said one or more reference samples; selecting an intra prediction mode from said set of intra prediction modes; and performing intra prediction for said block to be encoded to form a prediction block for said block, based on said intra prediction mode for said block.

According to another embodiment, an apparatus for video decoding is presented, comprising one or more processors, wherein said one or more processors are configured to: identify availability of one or more reference samples for a block to be decoded in a picture; obtain a set of intra prediction modes for said block, responsive to said availability of said one or more reference samples; obtain an intra prediction mode from said set of intra prediction modes; and perform intra prediction for said block to be decoded to form a prediction block for said block, based on said intra prediction mode for said block.

According to another embodiment, an apparatus for video encoding is presented, comprising one or more processors, wherein said one or more processors are configured to: identify availability of one or more reference samples for a block to be encoded in a picture; obtain a set of intra prediction modes for said block, responsive to said availability of said one or more reference samples; select an intra prediction mode from said set of intra prediction modes; and perform intra prediction for said block to be encoded to form a prediction block for said block, based on said intra prediction mode for said block.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for video encoding or decoding according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4 illustrates reference samples for intra prediction.

FIG. 5A and FIG. 5B illustrate reference sample substitution for intra prediction.

FIG. 6 illustrates a process of reference sample substitution for intra prediction.

FIG. 7A illustrates intra prediction directions in HEVC, FIG. 7B illustrates intra prediction directions in VVC, and FIG. 7C illustrates horizontal and vertical, positive and negative intra prediction modes.

FIG. 8A, FIG. 8B and FIG. 8C illustrate wide-angle intra prediction.

FIG. 9 illustrates all available intra prediction directions in VVC.

FIG. 10 illustrates the Planar mode.

FIG. 11 illustrates the reference samples used for each Intra Prediction Mode (IPM) on a PU of aspect ratio W/H=4.

FIG. 12A illustrates a CB inside an intra slice, FIG. 12B illustrates unavailable reference samples, and FIG. 12C illustrates removed intra prediction modes.

FIG. 13A illustrates another CB inside an intra slice, FIG. 13B illustrates unavailable reference samples, and FIG. 13C illustrates removed intra prediction modes.

FIG. 14 illustrates a workflow of signaling the index of the intra prediction mode selected to predict the current W×H block on the encoder side, according to an embodiment.

FIG. 15 illustrates a workflow of decoding the index of the intra prediction mode selected to predict the current W×H block on the decoder side, according to an embodiment.

FIG. 16 illustrates the identification of the unavailable decoded reference samples around the current block using a search for already decoded blocks around the current block.

FIG. 17 illustrates a workflow of signaling the index of the intra prediction mode selected to predict the current W×H block on the encoder side, according to another embodiment.

FIG. 18 illustrates a workflow of decoding the index of the intra prediction mode selected to predict the current W×H block on the decoder side, according to another embodiment.

FIG. 19 illustrates the creation of the general list of 22 MPMs for the current luminance CB in ECM.

FIG. 20 illustrates the modified creation of the general list of 22 MPMs for the current luminance CB in ECM, according to an embodiment.

FIG. 21 illustrates the modified creation of the general list of 22 MPMs for the current luminance CB in ECM, according to another embodiment.

FIG. 22 illustrates the modified creation of the general list of 22 MPMs for the current luminance CB in ECM, according to another embodiment.

### DETAILED DESCRIPTION

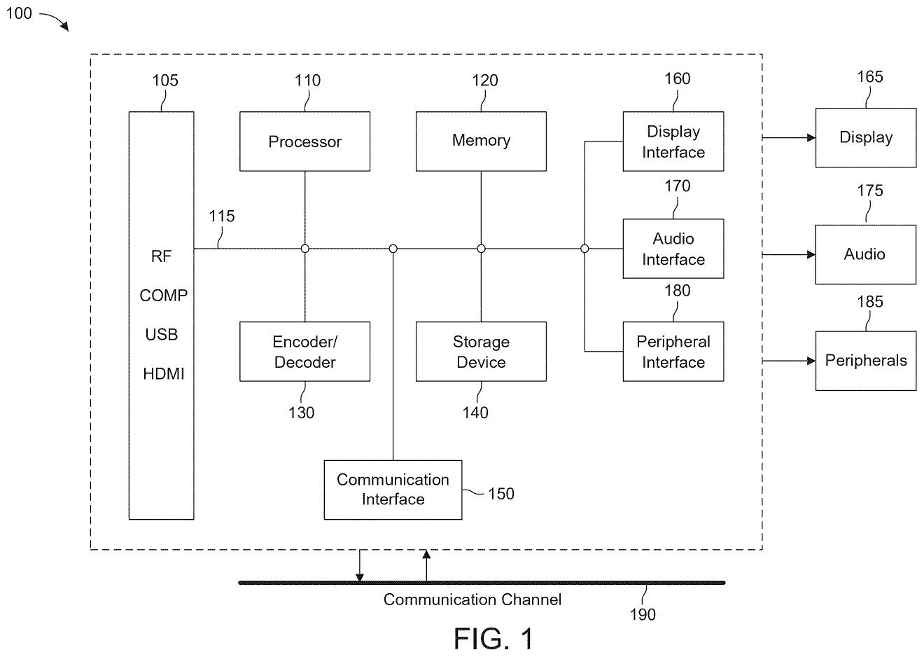

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

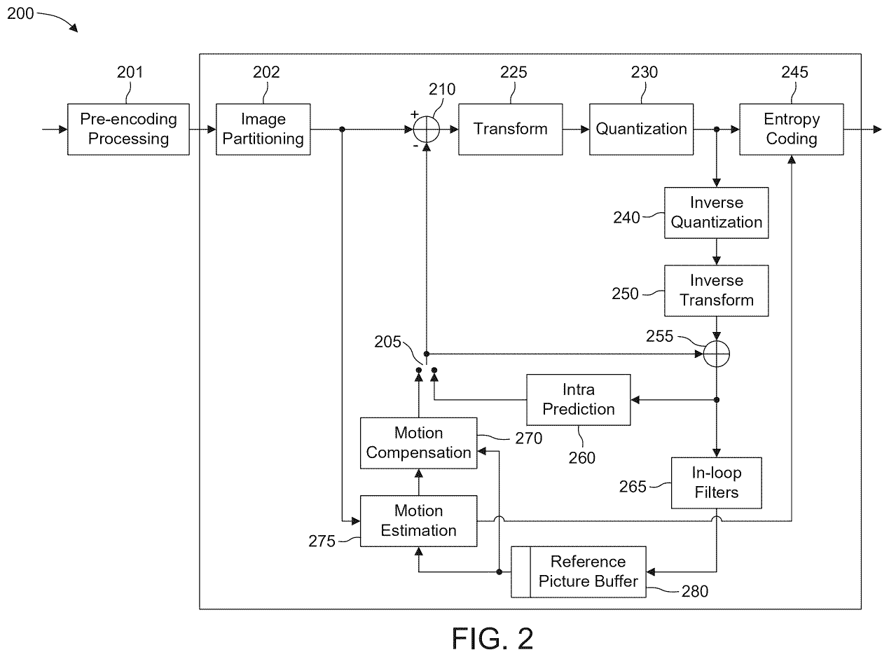

FIG. 2 illustrates an example video encoder 200, such as a VVC (Versatile Video Coding) encoder. FIG. 2 may also illustrate an encoder in which improvements are made to the VVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs (Coding Units). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements such as the picture partitioning information, are entropy coded (245) to output a bitstream. As a non-limiting example, context-based adaptive binary arithmetic coding (CABAC) can be used to encode syntax elements into the bitstream.

The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset)/ALF (Adaptive Loop Filter) filtering to reduce encoding artifacts. The filtered image is stored in a reference picture buffer (280).

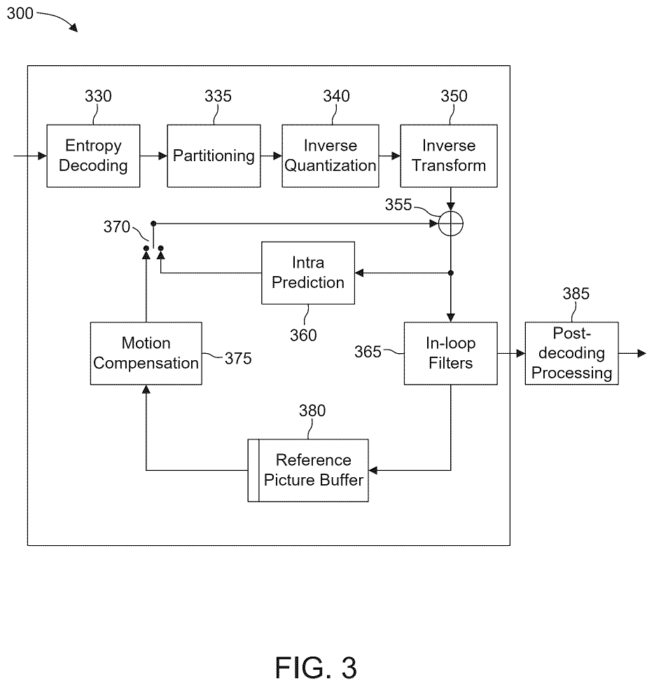

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, prediction modes, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380). Note that, for a given picture, the contents of the reference picture buffer 380 on the decoder 300 side is identical to the contents of the reference picture buffer 280 on the encoder 200 side for the same picture.

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

### Intra Prediction and Reference Samples Substitution

The intra prediction process in HEVC and VVC consists of three steps:
Reference sample generation;
Intra sample prediction; and
Post-processing of predicted samples.

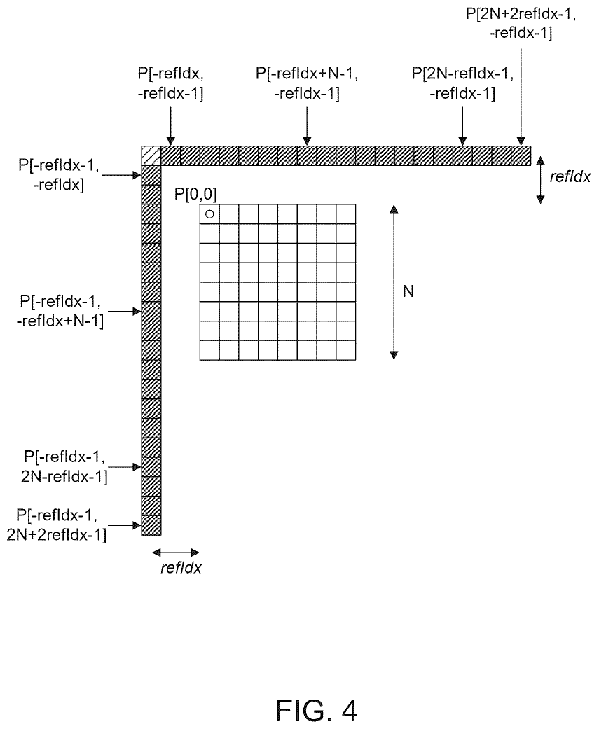

The reference sample generation process is illustrated in FIG. 4. The pixel values at co-ordinates (x,y) are indicated by P(x,y). The reference samples ref[ ] are also known as L-shape. For a prediction unit (PU) of size N×N, a row of (2N+2*refIdx) decoded samples on the top is formed from the previously reconstructed top and top-right pixels. Similarly, a column of (2N+2*refIdx) samples on the left is formed from the reconstructed left and below-left pixels. In VVC, the reference line and column of samples may be at a distance (d=refIdx) of more than one sample to the current block as depicted in FIG. 4. An index “mrlIdx” is signalled to indicate which value of “d” should be used.

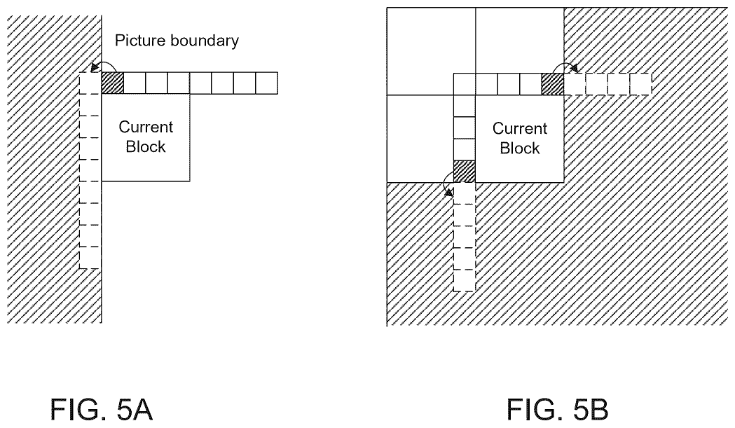

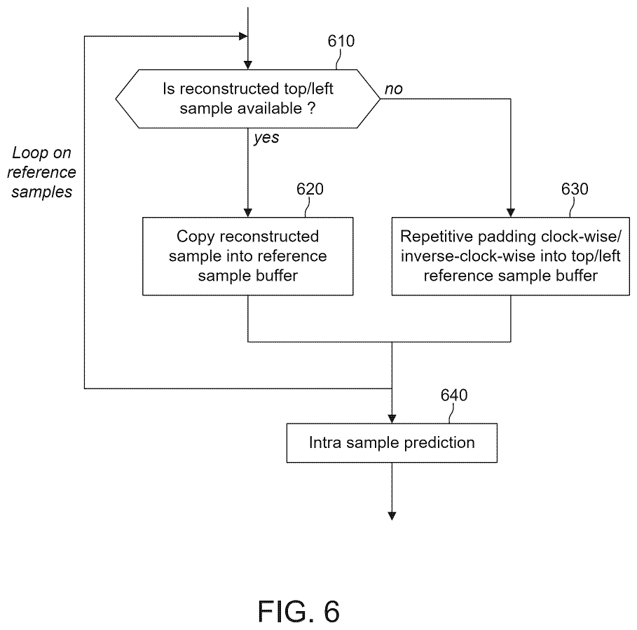

The corner pixel at the top-left position is also used to fill up the gap between the top row and the left column references. In FIG. 5A and FIG. 5B, the dashed area corresponds to the region of the picture not available (e.g., out of bounds or not yet reconstructed) and the missing reference samples are in dot-line. As shown in FIG. 6, if some of the samples on top or left are not available (610), because of the corresponding CUs not being in the same slice, or the current CU being at a frame boundary, for example, as shown in FIG. 5A, or the current CU being at the bottom-right after a quadtree split, for example, as shown in FIG. 5B, then a method called reference sample substitution is performed where the missing samples are copied from the available samples in a clock-wise and inverse clock-wise direction (630). Those copied samples are also referred to as “padded reference samples,” and when reconstructed samples are used as reference samples, they are also referred to as “non-padded reference samples.”

If reconstructed top/left reference samples are available, the reconstructed reference samples are copied (620) to the reference sample buffer. After the reference sample substitution process, intra sample prediction is performed (640). Then, depending on the current CU size and the prediction mode, the reference samples are filtered using a specified filter.

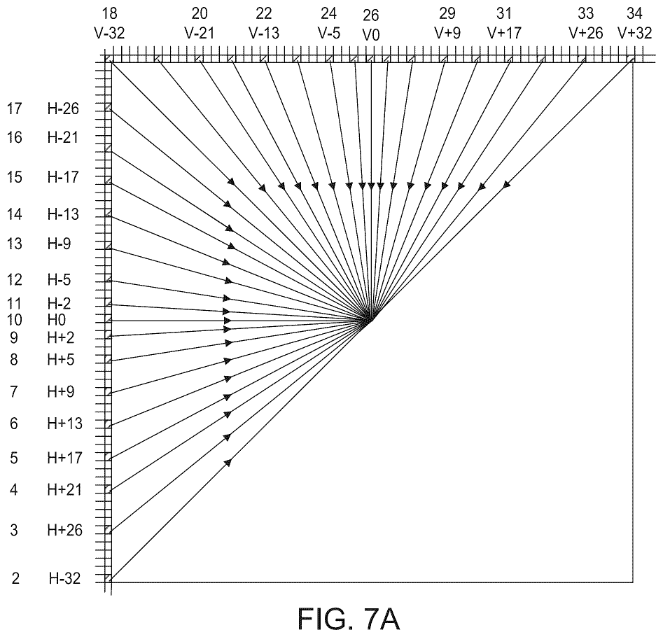

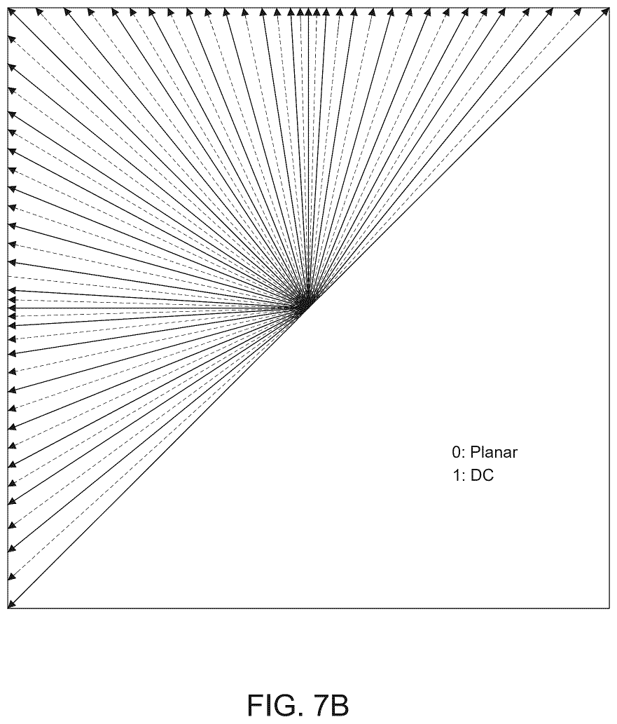

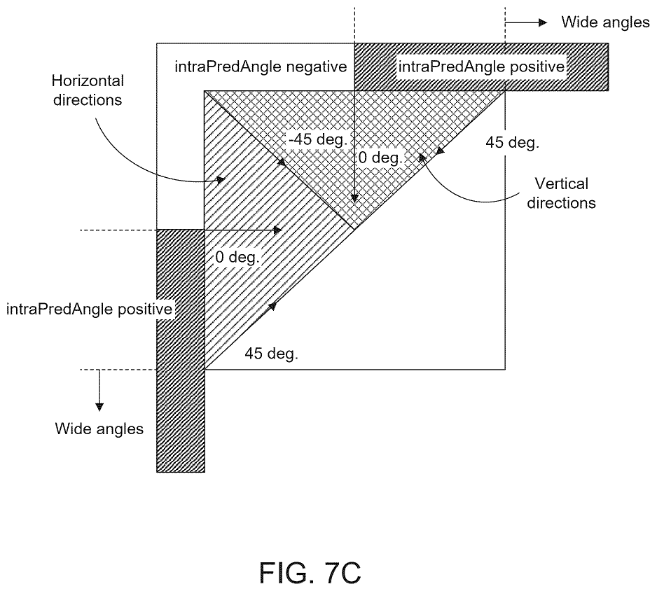

The intra sample prediction consists of predicting the pixels of the target CU based on the reference samples. There exist different prediction modes. Planar and DC prediction modes are used to predict smooth and gradually changing regions, whereas angular (angle defined from 45 degrees to −135 degrees in clockwise direction) prediction modes are used to capture different directional structures. For a square block, HEVC supports 33 directional prediction modes which are indexed from 2 to 34. These prediction modes correspond to different prediction directions as illustrated in FIG. 7A. The number in the figure denotes the prediction mode index associated with the corresponding direction. Modes 2 to 17 indicate horizontal predictions (H−26 to H+32) and modes 18 to 34 indicate vertical predictions (V−32 to V+32).

In VVC, there are 65 angular prediction modes, corresponding to the 33 angular directions defined in HEVC, and further 32 directions each corresponding to a direction mid-way between an adjacent pair as illustrated in FIG. 7B. For a square block, modes less than 34 indicate horizontal predictions, modes larger than 34 indicate vertical predictions.

As mentioned above, the angular directions can be distinguished as either vertical or horizontal. As illustrated in FIG. 7C, the prediction modes in horizontal directions use either only left reference samples, or some left and some top reference samples. Similarly, the prediction modes in vertical directions use either only top reference samples, or some top and some left reference samples. The horizontal positive directions use only the left reference samples for prediction. Similarly, the vertical positive directions use only the top reference samples for prediction. Negative horizontal and vertical directions use reference samples both on the left and on the top for prediction.

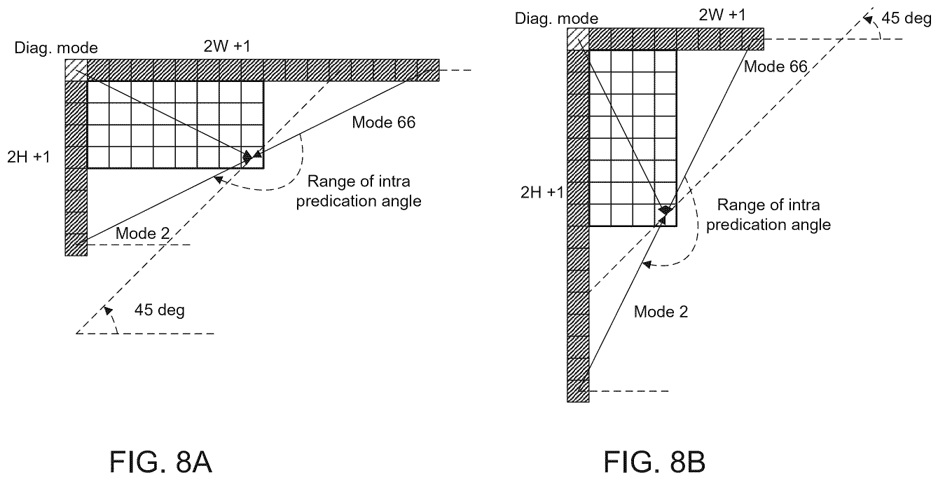

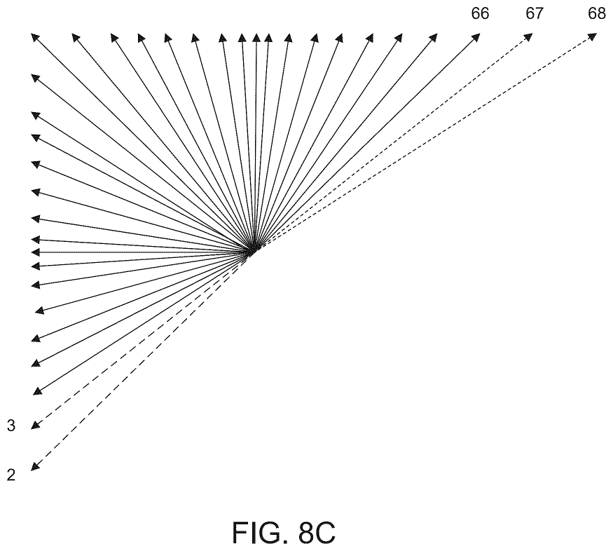

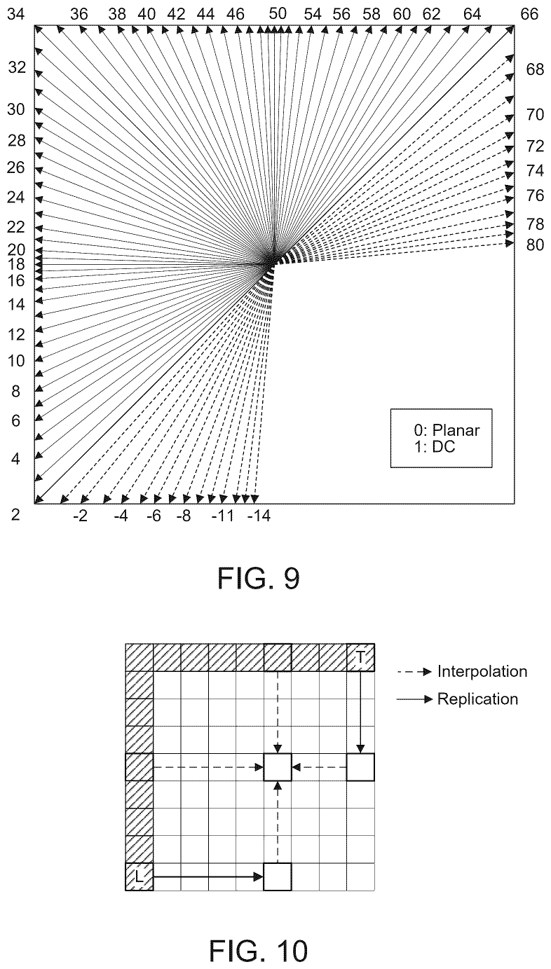

In VVC, for a non-square block, the regular directional intra prediction modes which are not allowed are replaced with wide-angle intra prediction modes as illustrated in FIG. 8A, FIG. 8B and FIG. 8C. Table 1 lists the replaced intra modes and the added wide-angular modes for different aspect ratios. Note that block ratios of 32 are included in Table 1 but cannot be used in practice as the partitioning does not allow for W/H=32 or H/W=32. In FIG. 9, dashed lines indicate Wide Angle Intra Prediction Modes (WAIP). Note that in ECM, indices −1 to −14 presented in FIG. 9 are remapped to go from 1 to −12, so that angular mode indices are continuous. Modes −15 (remapped to −13) and 81 are also not present in FIG. 9 as there are no block size that can use them, but those modes are handled by the reference software.

TABLE 1

| Aspect ratio | replaced intra prediction | |
|---|---|---|
| W/H | modes indices | Added angular modes |
| 2 | 2 to 7 | 67 to 72 |
| 4 | 2 to 11 | 67 to 76 |
| 8 | 2 to 13 | 67 to 78 |
| 16 | 2 to 15 | 67 to 80 |
| 32 | 2 to 16 | 67 to 81 |
| 1 | None | None |
| ½ | 61 to 66 | −4 to 1 |
| ¼ | 57 to 66 | −8 to 1 |
| ⅛ | 55 to 66 | −10 to 1 |
| 1/16 | 53 to 66 | −12 to 1 |
| 1/32 | 52 to 66 | −13 to 1 |

For a given angular prediction mode, the predictor samples on the reference arrays are copied along the corresponding direction inside the target PU. Some predictor samples may have integral locations, in which case they match with the corresponding reference samples; the location of other predictors will have fractional parts indicating that their locations will fall between two reference samples. In the latter case, the predictor samples are interpolated using the nearest reference samples (post-processing of predicted samples). In HEVC, a linear interpolation of the two nearest reference samples is performed to compute the predictor sample value. In VVC, to interpolate the predictor samples, 4-tap filters fT[ ] are used which are selected depending on the intra mode direction.

Besides directional modes, the DC mode fills-in the prediction with the average of the samples in the L-shape (except for rectangular CUs that use average of reference samples of the longer side), and the Planar mode interpolates reference samples spatially as illustrated in FIG. 10.

### Intra Prediction Mode Coding

Since there are multiple intra prediction modes available, the decoder needs the mode information to form the prediction for an intra-coded CU. The encoder encodes the mode information using one or more Most Probable Mode (MPM) sets. For example, ECM-5.0 (Enhanced Compression Model 5.0) uses a first MPM list (with 6 MPMs) and a secondary MPM list (with 16 MPMs). The first MPM list is constructed by sequentially adding candidate intra prediction mode indices based on the intra prediction mode indices used next to the current luminance coding block, with the first MPM index being reserved for the Planar mode. The neighboring indices added are the left neighbor, the above one, the bottom-left, above right and above left.

The secondary MPM list is constructed by first adding the indices of the first and second DIMD (Decoder-side Intra Mode Derivation) modes of the current luminance coding block, then adding incremented and decremented indices of the first angular MPMs (mpm[1]+1, mpm[1]−1, mpm[1]+2, mpm[1]−2, mpm[1]+3, mpm[1]−3, mpm[1]+4, mpm[1]−4, mpm[2]+1, mpm[2]−1, mpm[2]+2, mpm[2]−2, mpm[2]+3, mpm[2]−3, mpm[2]+4, mpm[2]−4, etc.) in such a way that no redundant mode index is present in the MPM list, neither in the primary MPM list nor in the secondary list. If the selected intra prediction mode does not belong to the first and secondary MPM lists, then the remaining Intra Prediction Modes (IPMs) are coded using a truncated binary encoding for 45 symbols.

In one embodiment, it is proposed to modify the intra prediction process so that wide angle intra prediction modes are not only chosen based on the block aspect ratio but also based on the availability of the reference samples. That way, IPMs that would normally mostly use padded reference samples would be disallowed while IPMs that normally are not allowed but, in practice, would be using non-padded reference samples would be allowed. The signaling is then modified to make use of the changes. This can be done by adding a context that uses this change to the CABAC coded bins, or by changing the code to handle added modes or removed modes, when the total number of modes differs from the original 67 indices.

The propagation of the intra mode is also modified to propagate more accurate mode values, and to handle cases where neither the neighboring intra mode nor its 180° counterpart is available for the current block.

### Select Available Intra Modes Based on Availability of Neighboring Reference Samples

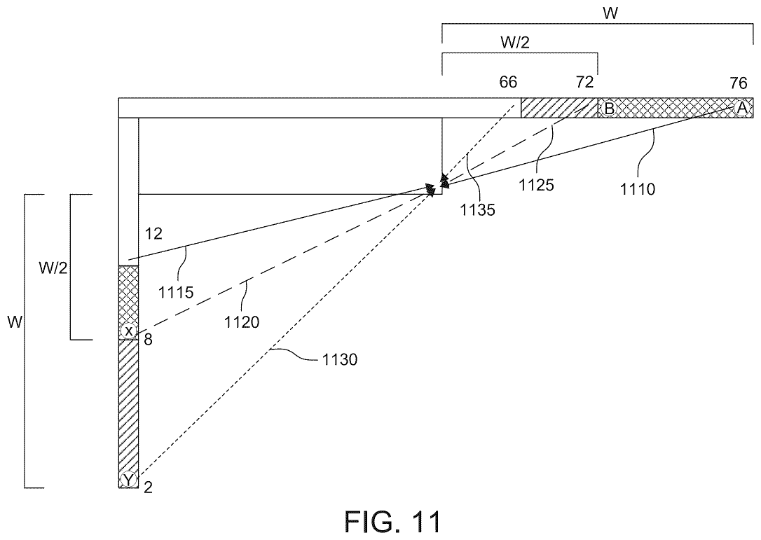

FIG. 11 illustrates which samples are tested for availability to know which IPMs use padded reference samples, according to an embodiment. The solid lines (1110, 1115) indicate the angular IPMs used by ECM-6.0 for a PU with a W/H ratio of 4 (modes 12 to 76). The dashed lines (1120, 1125) indicate the modes used by ECM-6.0 for a PU with W/H ratio of 2 (modes 8 to 72). The dotted lines (1130, 1135) indicate the modes used by ECM-6.0 for a PU with W/H ratio of 1 (modes 2 to 66).

As illustrated in FIG. 11, if a set of modes wish to only use available reference samples for intra prediction, it is possible to determine which samples need to be available for this set of modes for a specific block width/height ratio. For example, as shown in FIG. 11, if reference sample A is not available (then samples to the left of A may be also unavailable), then at least one mode from modes 73 to 76 (i.e., modes used for W/H=4 but not used for W/H<4) will use at least one padded sample. If reference sample B is not available (then all samples between A and B are not available), then all modes 73 to 76 will use at least one padded reference sample.

When the reference samples for an intra prediction mode is determined to be unavailable, we may decide to remove this intra prediction mode because the prediction would be of less quality. In addition, we can check if we can add back some other intra prediction modes if reference samples for these intra prediction modes are all available. Note that some of the intra prediction modes we propose to add back are the modes that are removed by the WAIP. But since these intra prediction modes use reconstructed reference samples (not padded reference samples), the prediction quality may still be better. For example, as illustrated in FIG. 11, if X is available (then all reference samples above X is available), then modes 8 to 11 (i.e., modes used for W/H=2 but not used for W/H>2) will use non-padded reference samples and can be added. If Y is available (then all reference samples above Y is available), then modes 2 to 7 (i.e., modes used for W/H=1 but not used for W/H>1) will use non-padded reference samples and can be added. Please note that we may perform the intra mode removal without adding back other intra prediction modes, or add some intra prediction modes without removing intra modes.

We may also use the intra prediction modes listed in Table 1 for removing/adding intra prediction modes. In one embodiment, the modes allowed are based on a set of modes designed for another block size. For example, depending on the available neighboring reference samples, a square block may use the modes designed for W/H=2 as shown in Table 1. Note here, some intra modes in the resulting set of intra modes may still use padded reference samples, but generally fewer padded samples are used than the original set of intra prediction modes. In the following, several examples are described in detail.

Let ref[0; 0] be the position of the top-left sample of the PU to encode/decode, let D be the distance of the reference line as given by mrlIdx, and let W and H be the width and height of the current PU.
If W>H,
   If top samples from ref[−1−D; −1−D] up to ref[2*W+W*D/H−1; −1−D] are available (i.e., non padded samples), then the set of modes defined for aspect ratio W/H can be used, e.g., the modes used in ECM-6.0 as described in Table 1 [E001];
   Otherwise (if at least one of those samples is not available), if all left-side samples from ref[−1−D; −1−D] up to ref[−1−D; H+W/2+H*D/(W/2)−1] are available, the set of modes defined for aspect ratio (W/2)/H can be used. Otherwise, (if at least one of those left-side samples is also not available), then the set of modes defined for aspect ratio W/H can be used. [E002]
Otherwise, if W<H,
   If left samples from ref[−1−D; −1−D] up to ref[−1−D; 2*H+H*D/W−1] are available (i.e., non padded samples), then the set of modes defined for aspect ratio W/H can be used, e.g., the modes used in ECM-6.0. [E003]
   Otherwise (if at least one of those samples is not available), if all top samples from ref[−1−D; −1−D] up to ref[W+H/2+W*D/(H/2)−1; −1−D] are available, the set of modes defined for aspect ratio W/(H/2) can be used. Otherwise, (if at least one of those top samples is also not available), then the set of modes defined for aspect ratio W/H can be used [E004].

The conditions in E001 and E003 check whether all samples are available for the WAIP modes. If at least one sample is not available it is possible that the regular ECM modes (i.e., the modes as defined in TABLE 1) are not used, based on subsequent conditions. In some embodiment, this first condition is more conservative, and the regular ECM modes are not used only if none of the samples they use is available. In such embodiments, E001 is written as:
If at least one top sample from ref[W+W/2+(W/2)*D/H; −1−D] up to ref[2*W−1+W*D/H; −1−D] is available (i.e., non-padded samples), then the set of modes defined for aspect ratio W/H can be used.

E003 is written as
If at least one left sample from ref[−1−D; H+H/2+(H/2)*D/W] up to ref[−1−D; 2*H−1+H*D/W] is available (i.e., non-padded samples), then the set of modes defined for aspect ratio W/H can be used.

The conditions E002 and E004 check if samples are available for the modes that are normally not used with ECM, and those modes are added only if all the samples are available. In some embodiments, this condition is relaxed, and the modes are added if at least one of the samples is available. In such embodiments E002 is written as:
Otherwise, if at least one left-side sample from ref[−1−D; 2*H+H*D/W] up to ref[−1−D; H+W/2+H*D/(W/2)−1] is available, the set of modes defined for aspect ratio (W/2)/H can be used. Otherwise, (if none of those samples is available), then the set of modes defined for aspect ratio W/H can be used.

E004 is written as
Otherwise, if at least one top samples from ref[2*W+W*D/H; −1−D] up to ref[W+H/2−1+W*D/(H/2); −1−D] is available, the set of modes defined for aspect ratio W/(H/2) can be used. Otherwise, (if none of those samples is available), then the set of modes defined for aspect ratio W/H can be used.

Some embodiments use combinations of those conditions. Some embodiments use different conditions depending on, but not limited to, block size, sequence size, QP or neighboring information.

In some embodiments, more modes are added. In such embodiments, when the set of ECM modes for W/H is replaced by the set of modes for (W/2)/H (resp., W/(H/2)), the tests E001 to E004 are performed again as if the width of the block was W/2 (resp, the height was H/2). If a new set of modes is selected this can be performed again until it is not preferred to change the set of modes to use.

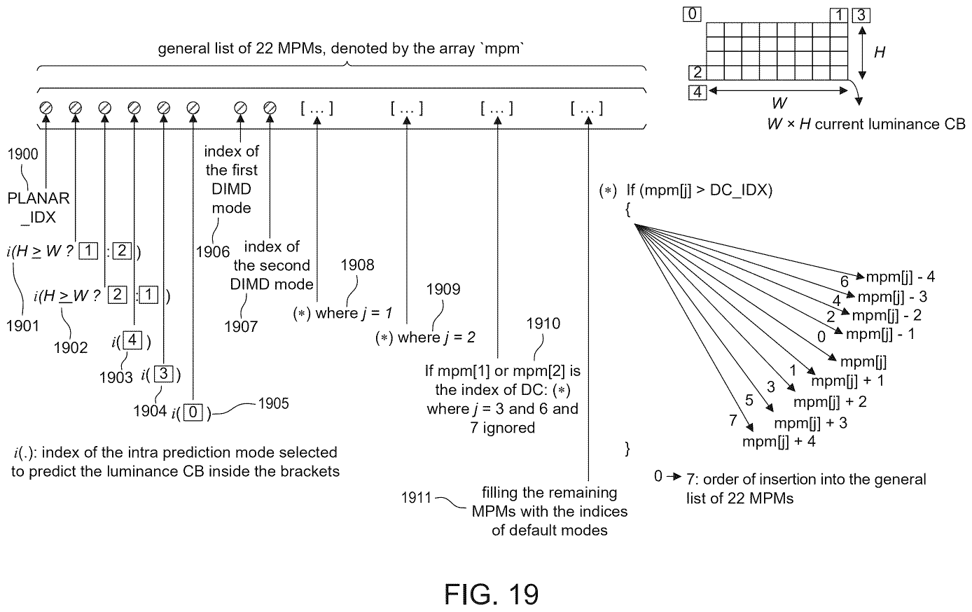

In some embodiments, the existing availability checks of neighboring CUs, used to construct the MPM list, can be used to determine if modes should be added or not. For example, tests on the availability of the reference samples are done at positions 1 and 2, then 3 and 4, as described in FIG. 19. In that case, the conditions [E001] to [E004] do not depend on whether W is greater than H or not. In an example, more modes would be added and none is removed, which can be especially useful when no signaling is needed, for example if the modes are added for TIMD or DIMD.

In one example, if top samples from ref[−1; −1] up to ref[W; −1] are available (i.e., non padded samples up to position 1), then all the modes defined for aspect ratio 2*W/H as described in Table 1 can be used in addition to the modes already allowed for this CU. If top sample ref[2*W; −1] is also available (i.e., non padded sample), then all the modes defined for aspect ratio 4*W/H as described in Table 1 can also be used in addition to the modes already allowed for this CU. If left samples from ref[−1; −1] up to ref[−1; H] are available (i.e., non padded samples up to position 2), then all the modes defined for aspect ratio W/(H*2) as described in Table 1 can be used in addition to the modes already allowed for this CU. If top sample ref[−1; 2*H] is also available (i.e., non padded sample), then all the modes defined for aspect ratio W/(H*4) as described in Table 1 can also be used in addition to the modes already allowed for this CU.

### Signaling of the Intra Modes

In some embodiments, the number of available IPMs is maintained to always be 67, with a fixed number of 65 angular IPMs. In such embodiments, no signaling changes are required. In other embodiments, the context of a CABAC coded bin for a syntax element associated with intra mode signaling, for example, the primary MPM flag, secondary MPM flag, or the first MPM index flag, can be modified to account for the available modes. For example, one of three context model indices would be chosen depending on the following conditions:
1) The IPMs used are the same as the one currently in ECM-6.0. On a PU with W/H=1, for example, those would be the angular modes 2 to 66, as well as Planar and DC.
2) The IPMs used are changed, to make use of IPMs usually available for modes with a greater W/H ratio. On a PU with W/H=1, for example, this would mean using the angular modes from I to I+64 with I>2, as well as Planar and DC.
3) The IPMs used are changed, to make use of IPMs usually available for modes with a smaller W/H ratio. On a PU with W/H=1, for example, this would mean using the angular modes from I to I+64 with I<2, as well as Planar and DC.

In some embodiment, the flag intra_luma_mpm_flag, used to specify if the intra mode used in the current luminance CB is in the MPM list has its syntax changed as follows according to Table 128 in the VTM specification text:

| | binIdx | | | | | |
|---|---|---|---|---|---|---|
| Syntax element | 0 | 1 | 2 | 3 | 4 | >=5 |
| intra_subpartitions_split_flag | 0 | na | na | na | na | na |
| intra_luma_mpm_flag[ ][ ] | [symbol] 0, 1, 2 | na | na | na | na | na |
| | (intra_mode_set_diff[ ][ ]) | | | | | |
| intra_luma_not_planar_flag[ ][ ] | intra_subpartitions_mode_flag | na | na | na | na | na |

The value of intra_mode_set_diff is derived as follows:
If the set of modes used for the current luminance CB of width and height W and H, at position posX, posY, is the set designed for the blocks of ratio W/H, as defined in Table 1, intra_mode_set_diff[posX][posY] is set to 0.
Otherwise, if the set of modes is designed for blocks of ratio strictly greater than W/H, intra_mode_set_diff[posX][posY] is set to 1.
Otherwise, intra_mode_set_diff[posX][posY] is set to 2.

The context model initializations are as follow, as defined by Table 70 in VTM specification text:

TABLE 70
Specification of initValue and shiftIdx for
ctxIdx of intra_luma_mpm_flag

| Initialization | ctxIdx of intra_luma_mpm_flag | | | | | | | | |
|---|---|---|---|---|---|---|---|---|---|
| variable | 0 | 1 | 2 | 3 | 4 | 5 | 6 | 7 | 8 |
| initValue | EP | EP | EP | EP | EP | EP | EP | EP | EP |
| shiftIdx | 0 | 0 | 4 | 0 | 0 | 1 | 0 | 0 | 1 |

In some embodiments, three contexts would be defined depending on if:
1) The IPMs used are the same as the one currently in ECM-6.0. On a PU with W/H=1, for example, those would be the angular modes 2 to 66, as well as Planar and DC.
2) The IPMs used are changed, to make use of IPMs usually available for modes with a greater abs(log 2(W/H)) ratio. On a PU with W/H≥1 (resp. W/H≤1), this would mean using the angular modes from I to I+64 with I>J (resp. I<J), J being the smallest angular mode normally available on this PU, as well as Planar and DC.
3) The IPMs used are changed, to make use of IPMs usually available for modes with a greater abs(log 2(W/H)) ratio. On a PU with W/H>1 (resp. W/H<1), this would mean using the angular modes from I to I+64 with I<J (resp. I>J), J being the smallest angular mode normally available on this PU, as well as Planar and DC.

In some embodiments, the previously mentioned rules can be reduced to using only 2 CABAC contexts (i.e., depending on if the modes are changed or not). In some embodiments, those rules can be combined with other information such as, but not restricted to, PU size, sequence size, QP, prediction tools used.

In some embodiments, the number of modes available differs from PU to PU, and the signaling therefore varies to account for the different number of modes. In one embodiment, the first and secondary MPM lists keep their original number of flags to be coded with, and the remaining IPMs are coded using a truncated binary encoding for N−22 symbols, where N is the number of available modes for this PU (with N=45 meaning using the same signaling as in ECM-6.0, N>45 means that more modes are available than in ECM-6.0, and N<45 meaning that fewer modes are available than in ECM-6.0).

In some embodiments, the restrictions on the availability of IPMs are limited to TIMD (Template-based Intra Mode Derivation) and/or DIMD, and/or other decoder-side tools, to avoid requiring any change in signaling. In such embodiments, the TIMD search (resp. DIMD search, and/or other decoder side tools) may be limited to the IPMs considered available.

In embodiments where TIMD can use the additional wide angles, only a subset of modes is added to reduce the complexity increase of the search. The additional modes can be included in the first part of the search, for example, as described in the follows.

Let W and H be the width and height of the block to encode, let minOrg and maxOrg be the smallest and highest angular intra modes values available for the current block, using TIMD's values for 131 modes (for example, from Table 1, angular modes go from 8 to 72 for W/H=2, which corresponds to minOrg=13 and maxOrg=141), and let newMin and newMax be the new smallest and highest angular intra modes values available for the current block, determined, for example, from the E001 to E004 (for example, if all neighboring samples are available for a block with W/H=2, modes from −4 to 7 and modes from 73 to 78 are added as per Table 1, meaning newMin=−9 and newMax=153 using TIMD's values for 131 modes). Starting from newMin+1 with a step size of N (e.g., N=5) and up to newMax, if the mode is not between minOrg and maxOrg, it is added to the first part of the TIMD search; otherwise, the mode is not added.

It can also be chosen to always add specific modes to the search. For example, newMin+1, orgMin−1, orgMax+1 and newMax+1 can be selected to be always added to the first part of the search. Those modes can either be the only ones to add in the search, to reduce the complexity of the design; or they can be added on top of the modes already added, to maximize the compression gains. The second part of the TIMD search (the refinement part) can be done as in ECM.

In some embodiments, before decoding the IPM index, if some additional modes are found to be available, an additional flag is decoded to indicate whether the original 67 modes allowed for the current block size are used, or if one of the N additional modes is used. If one of the N additional modes is used, an additional index is decoded using a truncated binary code for N symbols.

### Propagation of the Intra Direction

In ECM, if the neighboring block to the left has W/H=2 and uses angular mode 67 for prediction, the mode index used to construct the MPM list of the current block is 2. However, if the current luminance block is square, index 2 corresponds to angular mode 2. Therefore, using the mode index of neighboring modes to construct the MPM list of the current block can lead to add modes in the MPM lists that were never actually used, and should therefore not be considered as “most probable” to decode the current luminance coding block. Moreover, in ECM, each index can correspond to two different angular modes (for example index 2 is either angular mode 2 or angular mode 67, index 3 is either angular mode 3 or angular mode 68, etc.) but the two different modes are not opposite of 180°.

Two modes being opposite by 180° means that they predict the same directional texture (angular modes 2 and 66 both predict a direction of 45°) but from a different reference (angular mode 2 predicts from the bottom left to the top right and angular mode 66 predicts from the top right to the bottom left).

In some embodiments, the creation of the MPM list is made from the actual mode used by the neighboring block instead of the index used. For example, when constructing the MPM list and the neighboring modes are not available the mode is replaced by the corresponding mode at 180°, i.e., if the mode IPM is under 34 the mode is replaced by IPM+64, and otherwise the mode is replaced by IPM−64. In ECM up to ECM-6.0 this is always possible as there is always a span of 180° angular modes.

In encoders or decoders that remove some modes without adding others, for example encoders or decoders described in some of the previous embodiments, this may not be the case. If during the MPM list construction, a mode should be added that is not available in the current luminance CB, the mode is replaced by the closest available mode. In some embodiments, the modes are selected to always have a span of 65 angular modes to ensure that any angle is available and that it is always possible to replace a mode with its 180° counterpart.

### Beyond the Wide-Angle Intra Modes

The selection of the available intra prediction modes based on the availability of neighboring decoded reference samples can be extended to rules that no longer involve Table 1. This means that, for a given W×H block, depending on the availability of its neighboring decoded reference samples, its set of available intra prediction modes for its effective ratio W/H, see Table 1, will no longer be replaced by a different set of available intra prediction modes associated to a ratio of width and height close to its effective ratio W/H. Instead, for a given availability of the neighboring decoded reference samples of the given W×H block, a given number of intra prediction modes may be removed.

For instance, the rule potentially suppressing intra prediction modes may be as follows. For a given W×H block, if none of the W decoded reference samples located on its above-right side is available, the last n₀∈ [symbol] positive vertical intra prediction modes are disallowed (e.g., n₀=4). The “last” n₀ positive vertical intra prediction modes refer to the n₀ positive vertical intra prediction modes with largest angles in absolute value with respect to the vertical axis. Following the ECM nomenclature, the “last” n₀ positive vertical intra prediction modes refer to the n₀ positive vertical intra prediction modes with largest indices. If none of the H decoded reference samples located at the bottom-left side is available, the first n₁∈ [symbol] positive horizontal intra prediction modes are disallowed (e.g., n₁=4). The “first” n₁ positive horizontal intra prediction modes refer to the n₁ positive horizontal intra prediction modes with largest angles in absolute value with respect to the horizontal axis. Following the ECM nomenclature, the “first” n₁ positive horizontal intra prediction modes refer to the n₁ positive horizontal intra prediction modes with smallest indices. These indices can take negative values in case of wide-angle intra prediction.

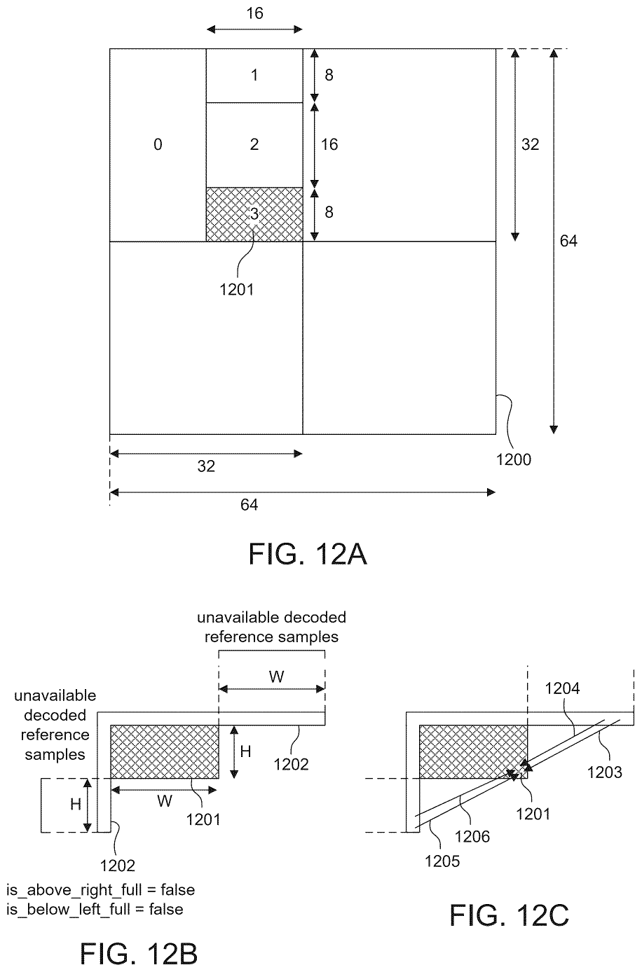

As an example, this rule may be illustrated in FIG. 12, in the case of a given W×H luminance Coding Block (CB) belonging to an intra slice in ECM-5.0. For this given luminance CB (1201) inside an intra slice in ECM-5.0, the disallowed intra prediction modes are identified from the partitioning history of (1201). Here, W=16 and H=8. The indices 0, 1, 2, and 3 indicate the order for encoding/decoding the first four luminance CBs belonging to the first 64×64 luminance CB (1200) resulting from the QT split of the considered luminance CTB.

In this example, it is essential to note that, for this given W×H luminance CB, at encoding time, the availability of its neighboring decoded reference samples can be completely specified before writing any bit of the partitioning of its parent luminance Coding Tree Block (CTB) to the bitstream, i.e. before writing any bit associated to the intra prediction within its parent luminance CTB. For this given W×H luminance CB, at decoding time, the availability of its neighboring decoded reference samples can be fully specified right after reading the bits of the partitioning of its parent luminance CTB from the bitstream, i.e., before reading any bit associated to the intra prediction within this parent luminance CTB. In the examples below, in ECM-5.0, the CTU size is set to 128, as in VVC, to get examples more comparable to their versions in VVC.

On the encoder side, a given 128×128 luminance CTB is split into four 64×64 luminance CBs via Quad-Tree (QT). For instance, the first 64×64 luminance CB (1200) is considered. Let us characterize the split at a given depth by (typeSplit, idxChild), “typeSplit” referring to the type of split in {Quad-Tree (QT), Binary-Tree Horizontal (BT_H), Binary-Tree Vertical (BT_V), Ternary-Tree Horizontal (TT_H), Ternary-Tree Vertical (TT_V)} and “idxChild” denoting the index in the encoding order of the considered child CB resulting from this split. Then, the partitioning of the considered luminance CB (1201) is fully described by its split tree {(QT, 0), (QT, 0), (BT_V, 1), (TT_H, 2)}, as shown in FIG. 12A. From this split tree, the fact that none of the W decoded reference on the above-right side of (1201) is available and none of the H decoded reference samples on the bottom-left side of (1201) is available becomes obvious.

These two portions of unavailable decoded reference samples are summarized as (1202) in FIG. 12B. For instance, this may be indicated by the flags “is_above_right_full” at 0 and “is_below_left_full” at 0 respectively attached to (1201). The last n₀ positive vertical intra prediction modes are disallowed, (1204) and (1203) representing the direction of the intra prediction mode of smallest index and that of largest index respectively in this set of disallowed modes. The first n₁∈ [symbol] positive horizontal intra prediction modes are disallowed, (1205) and (1206) representing the direction of the intra prediction mode of smallest index and that of largest index respectively in this set of disallowed modes, as shown in FIG. 12C.

Finally, the signaling of the index of the intra prediction mode selected to predict (1201) is adapted to take into consideration the removed intra prediction modes. For instance, if the selected intra prediction mode is not Template-based Intra Prediction (TMP), Decoder-side Intra Mode Derivation (DIMD), Template-based Intra Mode Derivation (TIMD), or a Matrix-based Intra Prediction (MIP) mode, does not use MRL, and is not an MPM, its index is truncated-binary encoded with code length N−n₀−n₁. Note that, as ECM-5.0 contains 67 regular intra prediction modes (65 directional, Planar, and DC), 6 primary MPMs, and 16 secondary MPMs, the index of a regular intra prediction mode not being an MPM can have N=45 possibilities.

On the decoder side, the process follows that on the encoder side, except for the signaling of the index of the intra prediction mode selected to predict (1201). Given the above example, if the selected intra prediction mode is not TMP, DIMD, TIMD, or a MIP mode, does not use MRL, and is not an MPM, its index is decoded with a truncated-binary code for 45−n₀−n₁ possible symbols.

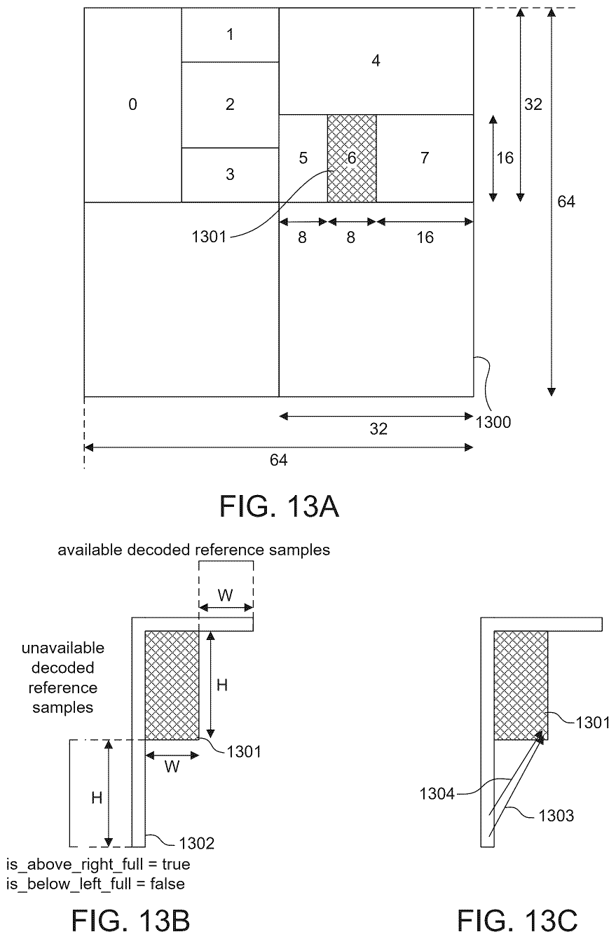

Another example of this embodiment can be depicted in FIG. 13, in the case of a given W×H luminance Coding Block (CB) belonging to an intra slice in ECM-5.0. For the given W×H luminance CB (1301) inside an intra slice in ECM-5.0, the disallowed intra prediction modes are identified from the partitioning history of (1301). Here, W=8 and H=16. The indices 0 to 7 indicate the order for encoding/decoding the first eight luminance CBs belonging to the first 64×64 luminance CB (1300) resulting from the QT split of the considered luminance CTB.

On the encoder side, a given 128×128 luminance CTB is split into 4 64×64 luminance CBs via QT. For instance, the first 64×64 luminance CB (1300) is considered. The partitioning of the considered luminance CB (1301) is fully specified by its split tree {(QT, 0), (QT, 1), (BT_H, 1), (BT_V, 0), (BT_V, 1)}, as shown in FIG. 13A.

From this split tree, the fact that all the W decoded reference on the above-right side of (1301) are available and none of the H decoded reference samples on the bottom-left side of (1301) is available, as shown (1302) in FIG. 13B, can be straightforwardly deduced. For instance, this may be indicated by the flags “is_above_right_full” at 1 and “is_below_left_full” at 0 respectively attached to (1301). The first n₁∈ [symbol] positive horizontal intra prediction modes are disallowed, (1303) and (1304) representing the direction of the intra prediction mode of smallest index and that of largest index respectively in this set of disallowed modes, as shown in FIG. 13C. Finally, the signaling of the index of the intra prediction mode selected to predict (1301) is adapted to take into account the removed intra prediction modes. For instance, if the selected intra prediction mode is not TMP, DIMD, TIMD, or a MIP mode, does not use MRL, and is not an MPM, its index is encoded with a truncated-binary code for 45−n₁ possible symbols.

On the decoder side, the process follows that on the encoder side, except for the signaling of the index of the intra mode selected to predict (1301). Given the above example, if the selected intra prediction mode is not TMP, DIMD, TIMD, or a MIP mode, does not use MRL, and is not an MPM, its index is decoded with a truncated-binary code for 45−n₁ possible symbols.

The above examples can be adapted to any other block in another channel/slice. Moreover, the rule for suppressing intra prediction modes depending on the availability of the neighboring decoded reference samples of the current block may be straightforwardly modified. For instance, this rule may become “For a given W×H block, if none of the rightmost W/2 decoded reference samples located on its above-right side is available, the last n₀∈ [symbol] positive vertical intra prediction modes are disallowed. If none of the bottommost H/2 decoded reference samples located at the bottom-left side is available, the first n₁∈ [symbol] positive horizontal intra prediction modes are disallowed.”

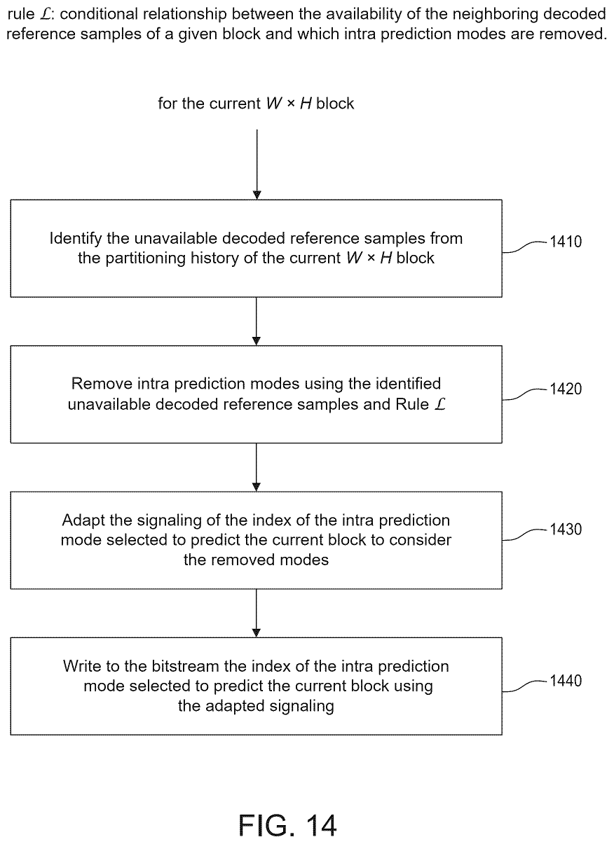

For a given W×H block, the workflow of encoding the index of the selected intra prediction mode on the encoder side following this embodiment can be summarized by FIG. 14. In this embodiment, the rule, which indicates the conditional relationship between the availability of neighboring reference samples of a given block and which intra prediction modes are removed for the given block, is known at the encoder side. In particular, for the current block, the encoder identifies (1410) the unavailable reference samples from the partitioning history of the current block. For example, for a partition history of {(QT, 0), (QT, 0), (BT_V, 1), (TT_H, 2)}, is_above_right_full=false and is_below_left_full=false in FIG. 12. Based on the identified unavailable reference samples and the Rule about removing intra prediction modes, the encoder removes (1420) some intra prediction modes (these intra prediction modes are not available to the current block). For example, for is_above_right_full=false and is_below_left_full=false, last n₀ positive vertical intra prediction modes and first n₁ positive horizontal intra prediction modes are disallowed in FIG. 12.

Considering the removed modes, the encoder adapts (1430) the signaling of the index of the intra prediction mode selected to predict the current block. Generally, the total number of available intra prediction modes is adjusted by decreasing by the amount of removed intra prediction modes. For example, if the selected intra prediction mode is not TMP, DIMD, TIMD, or a MIP mode, does not use MRL, and is not an MPM, its index is truncated-binary encoded with code length 45−n₀−n₁ in FIG. 12. Then the encoded index is written (1440) into the bitstream.

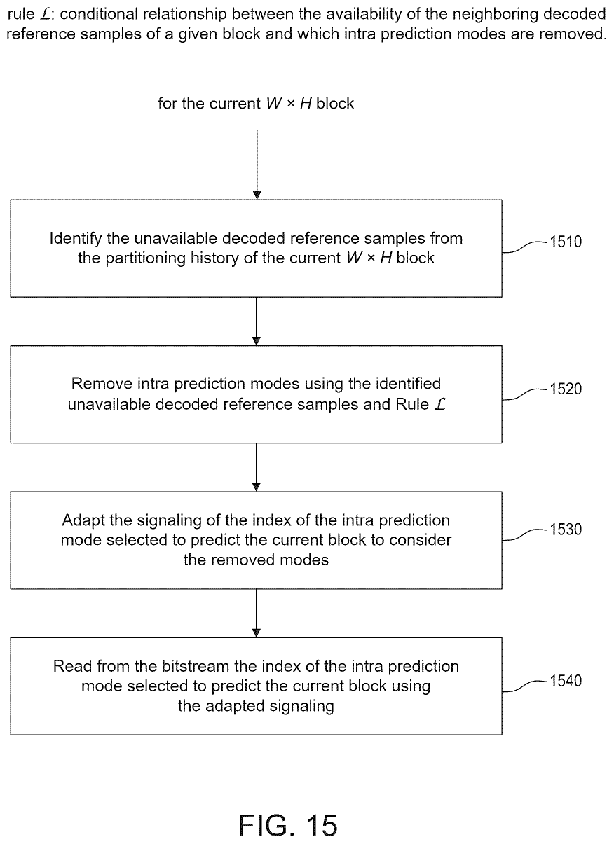

For this W×H block, the workflow of decoding the index of the selected intra prediction mode on the decoder side following this embodiment can be summarized in FIG. 15. The steps at the decoder side (1510, 1520, 1530, 1540) correspond to those at the encoder side.

These two figures illustrate the workflow for a single block only. When considering multiple blocks, the ordering of the steps in FIG. 14 and FIG. 15 depends on the codec of interest.

In FIGS. 12-15, for a given W×H block, the unavailable decoded reference samples are identified from the partitioning history of this block. In other embodiments, the unavailability of the decoded reference samples may be identified using a function searching for already decoded blocks around the current block.

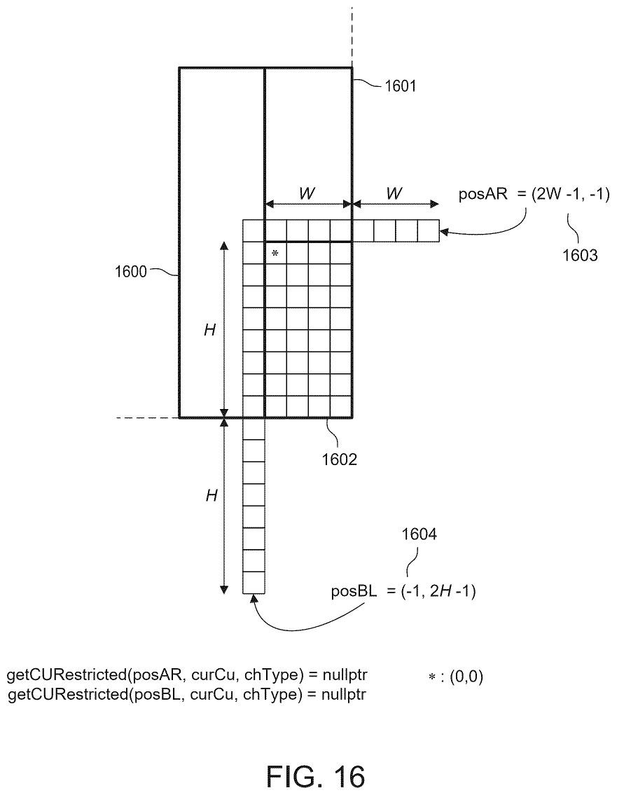

For example, as illustrated in FIG. 16, for a given W×H CB (1602) in an intra slice in ECM-5.0, the function “getCURestricted” takes a pixel position “pos”, e.g., “posAR” (1603) or “posBL” (1604), the Coding Unit (CU) “curCu” of the given W×H CB (1602), and the channel type “chType” of (1602), to return a pointer to the already decoded CB containing the pixel located at “pos”. If the pixel located at “pos” does not belong to any CB or it belongs to a CB that is not decoded yet, “getCURestricted” may return the pointer NULL, for instance “nullptr” in C++. In FIG. 16, the CBs (1600), (1601), and (1602) result from the last two split BT_V and BT_H at the current state of the encoding/decoding. For instance, in FIG. 16, as “posAR” belongs to a CB that is not decoded yet, “getCURestricted (posAR, curCu, chType)” returns “nullptr”.

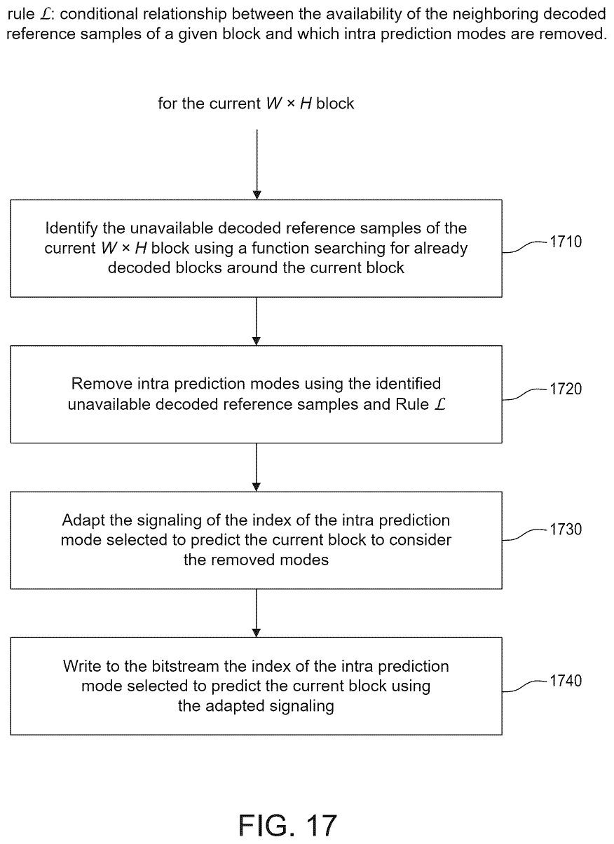

For a given W×H block, the workflow of encoding the index of the selected intra prediction mode on the encoder side following this embodiment can be summarized by FIG. 17. In particular, for the current block, the encoder identifies (1710) the unavailable reference samples from the partitioning history of the current block. For example, if getCURestricted (posAR, curCu, chType)=nullptr, then is_above_right_full=false; if getCURestricted (posBL, curCu, chType)=nullptr, then is_below_left_full=false in FIG. 16. Based on the identified unavailable reference samples and the Rule about removing intra prediction modes, the encoder removes (1720) some intra prediction modes (these intra prediction modes are not available to the current block). For example, for is_above_right_full=false and is_below_left_full=false, last n₀ positive vertical intra prediction modes and first n₁ positive horizontal intra prediction modes are disallowed.

Considering the removed modes, the encoder adapts (1730) the signaling of the index of the intra prediction mode selected to predict the current block. For example, if the selected intra prediction mode is not TMP, DIMD, TIMD or a MIP mode, does not use MRL, and is not an MPM, its index is truncated-binary encoded with code length 45−n₀−n₁. Then the encoded index is written (1740) into the bitstream.

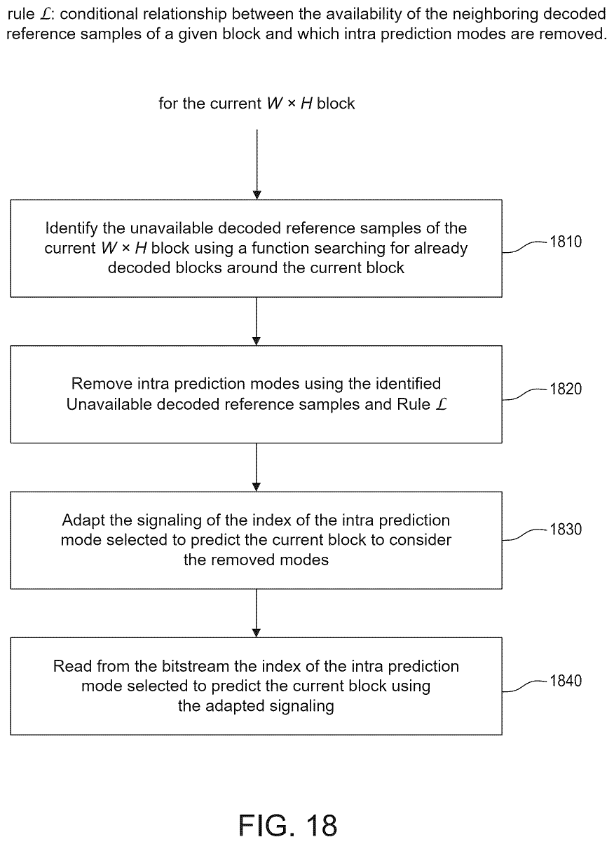

For this W×H block, the workflow of decoding the index of the selected intra prediction mode on the decoder side following this embodiment, can be summarized in FIG. 18. The steps at the decoder side (1810, 1820, 1830, 1840) correspond to those at the encoder side.

In another embodiment, for a given block, instead of removing a given number of intra prediction modes depending on the availability of its neighboring decoded reference samples, its list of MPMs may be reordered such that, for some intra prediction modes intensively using unavailable decoded reference samples for prediction and having their indices inside this list of MPMs, their indices are moved towards the end of this list of MPMs. The intra prediction modes whose indices are moved towards the end of the list of MPMs of the given block are viewed as relatively less probable of being selected as the intra prediction mode predicting the given block.

An embodiment for the current W×H luminance CB in an intra slice in ECM-5.0 is depicted in FIG. 19. In particular, FIG. 19 shows, for the current given W×H luminance CB, the creation of the general list of 22 MPMs of this luminance CB. The first 6 MPMs in the general list of MPMs correspond to the list of primary MPMs whereas the last 16 MPMs in the general list of MPMs yield the list of secondary MPMs.

In FIG. 19, the Planar mode is first added to the general list of MPMs (1900). Then, the indices of the intra prediction modes selected to predict the left, above, bottom-left, above-right, and above-left luminance CBs are added to the general list of MPMs (1901-1905). Then, the indices of the two intra prediction modes derived via DIMD for the current luminance CB are added to the general list of MPMs (1906, 1907). Then, if the current second MPM is neither PLANAR nor DC, the indices of its eight neighboring angular intra prediction modes are put into the general list of MPMs (1908). Then, if the current third MPM is neither PLANAR nor DC, the indices of its eight neighboring angular intra prediction modes are put into the general list of MPMs (1909).

After potentially adding indices of more angular intra prediction modes according to (1910), the indices of default modes are inserted into the general list of MPMs (1911) to reach 22 MPMs. Note that each of the above-mentioned insertions applies under the condition that no redundancy exists in the general list of MPMs. This means that, for the index of the current intra prediction to be inserted into the general list of MPMs, if this index already exists in this list, the insertion is skipped.

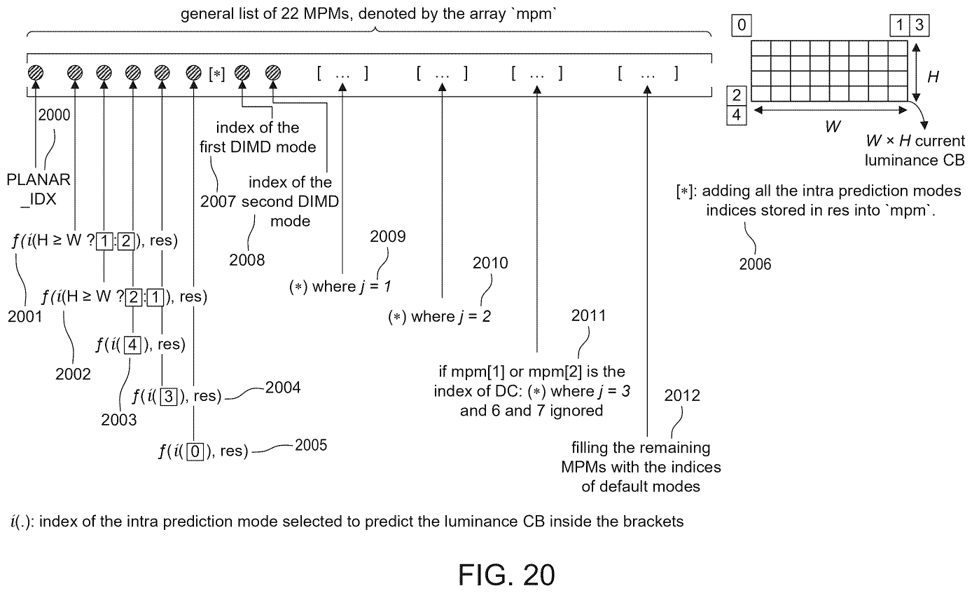

FIG. 20 illustrates the creation of the general list of 22 MPMs of the same current luminance CB, according to an embodiment. In FIG. 20, the creation of the general list of 22 MPMs for the current W×H luminance CB follows the workflow in FIG. 19, except that a reordering may be introduced. For example, the function ƒ may take as a first argument the index of a candidate intra prediction mode to be put into the general list of MPMs and as a second argument the array “res” of reserved mode indices. Then, if the candidate intra prediction mode is “valid” under a condition depending on the availability of the decoded reference samples of the current W×H luminance CB, ƒ may put the index of the candidate intra prediction mode into the general list of MPMs. Otherwise, ƒ may add the index of this intra prediction mode to “res”.

The Planar mode is first added to the general list of MPMs (2000). Then, the indices of the intra prediction modes selected to predict the left, above, bottom-left, above-right, and above-left luminance CBs are added to the general list of MPMs under the condition of validity defined via ƒ (2001-2005). Then, all the intra prediction modes indices stored in “res” are added to the general list of MPMs (2006). Then, the indices of the two intra prediction modes derived via DIMD for the current luminance CB are added to the general list of MPMs (2007, 2008). The last steps (2009), (2010), (2011), and (2012) follow (1908), (1909), (1910), and (1911) respectively in FIG. 19.

In another embodiment, ƒ may apply (or not apply) to the index of any candidate intra prediction mode to be potentially added to the general list of MPMs of the current luminance CB. Moreover, the step at which all the intra prediction modes indices stored in “res” are put into the general list of MPMs of the current luminance CB may occur at any time during the creation of the general list of MPMs.

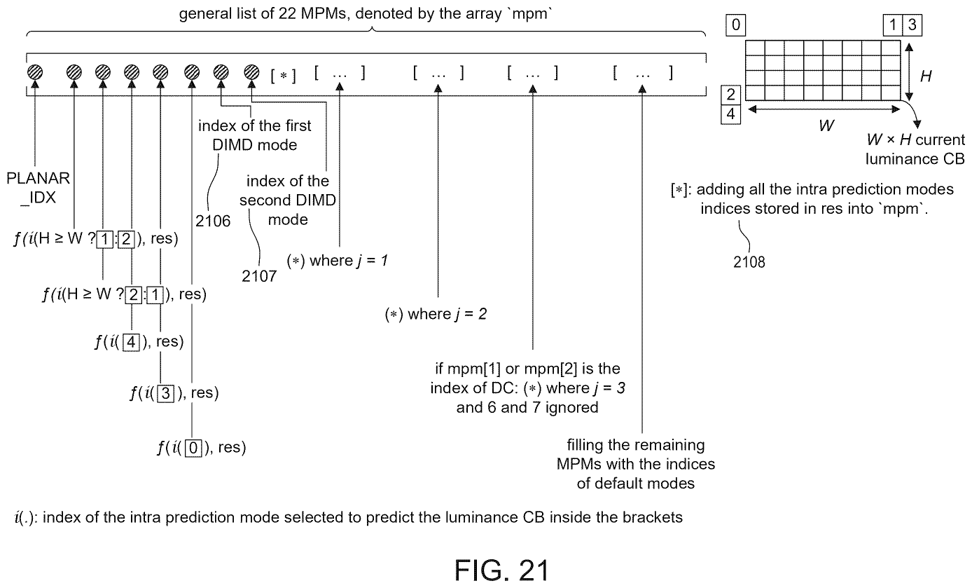

For instance, in an embodiment illustrated in FIG. 21, the addition of all the intra prediction modes stored in “res” (2108) occurs after potentially putting into the general list of MPMs the indices of the two intra prediction modes derived via DIMD for the current luminance CB (2106, 2107).

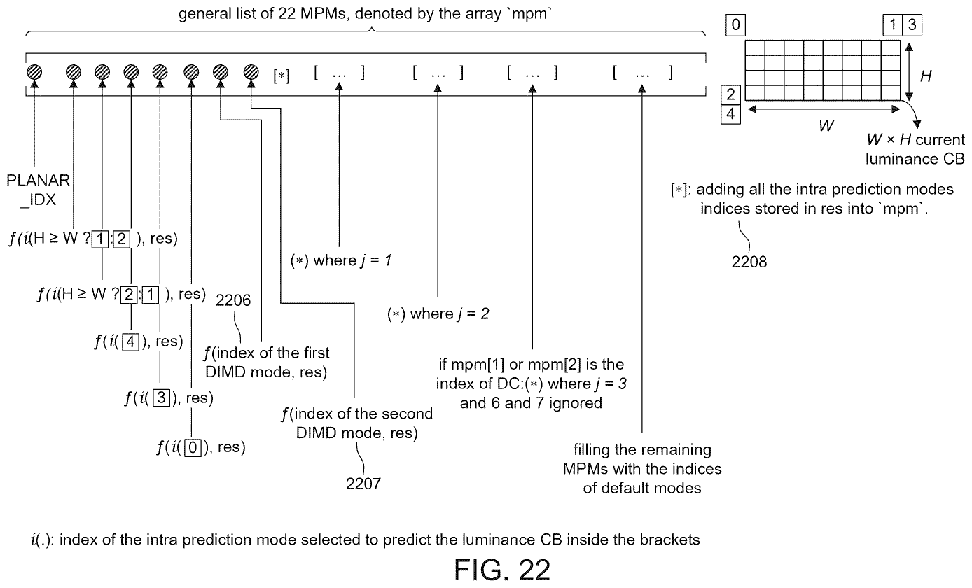

For instance, in another embodiment shown in FIG. 22, the addition of all the intra prediction modes stored in “res” (2208) occurs after potentially putting into the general list of MPMs the indices of the two intra prediction modes derived via DIMD for the current luminance CB under the condition of validity defined via ƒ (2206, 2207).

In one embodiment, the condition of validity defined by ƒ for the index of the intra prediction mode passed as the first argument may be that, if none of the W decoded reference samples located on the above-right side of the current W×H block is available, the last n₀∈ [symbol] positive vertical intra prediction modes are invalid (e.g., n₀=8). If none of the H decoded reference samples located at the bottom-left side of the current W×H block is available, the first n₁∈ [symbol] positive horizontal intra prediction modes are invalid (e.g., n₁=8).

In another embodiment, the condition of validity defined by ƒ for the index of the intra prediction mode passed as the first argument may be that, if none of the rightmost W/2 decoded reference samples located on its above-right side of the current W×H block is available, the last n₀∈ [symbol] positive vertical intra prediction modes are invalid (e.g., n₀=4). If none of the bottommost H/2 decoded reference samples located at the bottom-left side of the current W×H block is available, the first n₁∈ [symbol] positive horizontal intra prediction modes are invalid (e.g., n₁=4).

In yet another embodiment, the condition of validity defined by ƒ for the index of the intra prediction mode passed as the first argument may be that, if no decoded reference sample located above (including above-left, above, and above-right) of the current W×H block is available, the last q₀∈ [symbol] vertical intra prediction modes are invalid (e.g., q₀=8). If no decoded reference sample located on the left side (including above-left, left, and bottom-left) of the current W×H block is available, the first q₁∈ [symbol] horizontal intra prediction modes are invalid (e.g., q₁=8).

In yet another embodiment, the condition of validity defined by ƒ for the index of the intra prediction mode passed as the first argument may be a composition of several conditions depending on different states of availability of the decoded reference samples of the current W×H block. As an example, if no decoded reference sample located above (including above-left, above, and above-right) of the current block is available, the last q₀∈ [symbol] vertical intra prediction modes are invalid (e.g., q₀=8). Otherwise, the following condition is checked. If none of the W decoded reference samples located on the above-right side of the current block is available, the last n₀∈ [symbol] positive vertical intra prediction modes are invalid (e.g., n₀=5). As another example, if no decoded reference sample located on the left side (including above-left, left, and bottom-left) of the current block is available, the first q₁∈ [symbol] horizontal intra prediction modes are invalid (e.g., q₁=5). Otherwise, the following condition is checked. If none of the H decoded reference samples located at the bottom-left side of the current block is available, the first n₁∈ [symbol] positive horizontal intra prediction modes are invalid (e.g., n₁=5).

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the intra prediction modules (260, 360), of a video encoder 200 and decoder 300 as shown in FIG. 2 and FIG. 3. Moreover, the present aspects are not limited to ECM, VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of video decoding, comprising:
identifying availability of one or more reference samples for a block to be decoded in a picture;
obtaining a set of intra prediction modes for said block, responsive to said availability of said one or more reference samples;
obtaining an intra prediction mode from said set of intra prediction modes; and
performing intra prediction for said block to be decoded to form a prediction block for said block, based on said intra prediction mode for said block.

2. (canceled)

3. The method of claim 1, wherein said availability of said one or more reference samples is identified based on a partitioning history for said block.

4. The method of claim 1, wherein said obtaining a set of intra prediction modes comprises:
obtaining a first set of intra prediction modes; and
adjusting said first set of intra prediction modes to said set of intra prediction modes responsive to said availability of said one or more reference samples.

5. The method of claim 4, wherein said first set of intra prediction modes is obtained based on an aspect ratio of said block.

6. The method of claim 5, wherein said set of intra prediction modes is obtained based on a different aspect ratio than said aspect ratio of said block.

7. The method of claim 6, wherein said different aspect ratio is half or twice of said aspect ratio of said block.

8-15. (canceled)

16. An apparatus for video decoding, comprising one or more processors, wherein said one or more processors are configured to:
identify availability of one or more reference samples for a block to be decoded in a picture;
obtain a set of intra prediction modes for said block, responsive to said availability of said one or more reference samples;
obtain an intra prediction mode from said set of intra prediction modes; and
perform intra prediction for said block to be decoded to form a prediction block for said block, based on said intra prediction mode for said block.

17. (canceled)

18. The apparatus of claim 16, wherein said availability of said one or more reference samples is identified based on a partitioning history for said block.

19. The apparatus of claim 16, wherein said one or more processors are configured to obtain a set of intra prediction modes by:
obtaining a first set of intra prediction modes; and
adjusting said first set of intra prediction modes to said set of intra prediction modes responsive to said availability of said one or more reference samples.

20. The apparatus of claim 19, wherein said first set of intra prediction modes is obtained based on an aspect ratio of said block.

21-22. (canceled)

23. A method of video encoding, comprising:
identifying availability of one or more reference samples for a block to be encoded in a picture;
obtaining a set of intra prediction modes for said block, responsive to said availability of said one or more reference samples;
selecting an intra prediction mode from said set of intra prediction modes; and
performing intra prediction for said block to be encoded to form a prediction block for said block, based on said intra prediction mode for said block.

24. The method of claim 23, wherein said availability of said one or more reference samples is identified based on a partitioning history for said block.

25. The method of claim 23, wherein said obtaining a set of intra prediction modes comprises:
obtaining a first set of intra prediction modes; and
adjusting said first set of intra prediction modes to said set of intra prediction modes responsive to said availability of said one or more reference samples.

26. The method of claim 25, wherein said first set of intra prediction modes is obtained based on an aspect ratio of said block.

27. The method of claim 26, wherein said set of intra prediction modes is obtained based on a different aspect ratio than said aspect ratio of said block.

28. The method of claim 27, wherein said different aspect ratio is half or twice of said aspect ratio of said block.

29. An apparatus for video encoding, comprising one or more processors, wherein said one or more processors are configured to:
identify availability of one or more reference samples for a block to be encoded in a picture;
obtain a set of intra prediction modes for said block, responsive to said availability of said one or more reference samples;
select an intra prediction mode from said set of intra prediction modes; and
perform intra prediction for said block to be encoded to form a prediction block for said block, based on said intra prediction mode for said block.

30. The apparatus of claim 29, wherein said availability of said one or more reference samples is identified based on a partitioning history for said block.

31. The apparatus of claim 29, wherein said one or more processors are configured to obtain a set of intra prediction modes by:
obtaining a first set of intra prediction modes; and
adjusting said first set of intra prediction modes to said set of intra prediction modes responsive to said availability of said one or more reference samples.

32. The apparatus of claim 31, wherein said first set of intra prediction modes is obtained based on an aspect ratio of said block.
